(19) United States
(12) Patent Application Publication
(10) Pub. No.: US 2015/0313266 A1
(43) Pub. Date: Nov. 5, 2015

(54) FOOD FOR THE DIETARY MANAGEMENT OF BURNOUT

(71) Applicants: Igor Anatolievich POMYTKIN, Moscow (RU); Anton Sergeevich CHERNOPYATKO, Moscow (RU)

(72) Inventors: Igor Anatolievich POMYTKIN, Moscow (RU); Anton Sergeevich CHERNOPYATKO, Moscow (RU)

(21) Appl. No.: 14/649,213

(22) PCT Filed: Dec. 3, 2012
(86) PCT No.: PCT/RU2012/001009

§ 371 Date: Jun. 3, 2015

(51) Int. Cl. A23L 1/30; A23L 2/52

(52) U.S. Cl. CPC A23L 1/30; A23L 2/52; A23V 2002/00

(57) ABSTRACT

Food for the dietary management of burnout comprising a water containing from 0.0002 to 0.0278 mol. % of isotopologue HOD, preferably, from 0.0178 to 0.0278 mol. % of isotopologue HOD. Preferably, the food is selected from a group consisting of solid food, liquid food, beverage, and drinking water. Method of the dietary management of burnout comprising a step of administering to a subject in need thereof the food of the invention.

### FIELD OF THE INVENTION

The present invention is in the field of food industry and healthcare. More specifically, the present invention relates to foods for the dietary management of burnout.

### BACKGROUND OF THE INVENTION

In accordance with the International Classification of Diseases (ICD-10), the burnout (or “burn-out”) is defined under the code Z73.0 as the state of vital exhaustion. Occupational burnout is the state of physical, emotional and mental exhaustion that results from chronic work stress. As generally believed, burnout syndrome includes exhaustion, depersonalization (cynicism), and diminished professional efficacy. Burnout is a serious risk factor related to an increased prevalence of depressive and anxiety disorders and alcohol dependence among the men and women; musculoskeletal disorders among the women; and cardiovascular diseases among the men independently of socio-demographic factors, physical strenuousness of work, health behaviour, and depressive symptoms. Ah ola K. Occupational burnout and health. Finnish Institute of Occupational Health, Helsinki, Finland. People and Work. Research reports 81. 2007. Therefore, there is a great need in the management of burnout to reduce the risk of the development of diseases and improve professional efficacy of a subject in need thereof.

Although burnout syndrome may sometimes result in development of depression and sometimes include depression, burnout and depression are different states, which are clearly distinguished in the ICD-10, where burnout is classified under the code Z73.0, while depressive disorders are classified under the codes F32 and F33. Burnout and depression are statistically differentiated from each other. The items of a burnout inventory and a depression scale did not load on the same factor, as shown by results of factor analyses on cross-sectional data from four different studies on human service work. Ahola K. Occupational burnout and health. Finnish Institute of Occupational Health, Helsinki, Finland. People and Work. Research reports 81. 2007. Firth, H., KcKeown, P., Mclntee, J. & Britton, P. (1987) Professional depression, ‘burnout’ and personality in longstay nursing. International Journal of Nursing Studies 24, 227-237.

Water is an essential nutrient. Total water intake includes drinking water, water in beverages, and water contained in food. The adequate intake for total water was set based on the median total water intake from

U.S. survey data as 3.7 and 2.7 liters per day for men and women, respectively. Dietary Guidelines for Americans, 2005, U.S. Department of Health & Human Services. The natural water is a composition of nine water isotopologues (H₂¹⁶O, H₂¹⁷O, H₂¹⁸O, H¹⁶OD, H¹⁷OD, H¹⁸OD, D₂¹⁶O, D₂¹⁷O, D¹⁸O) formed by stable isotopes of hydrogen (H and D) and oxygen (¹⁶O, ¹⁷O, ¹⁸O), wherein content of major water isotopologue H₂O (H₂¹⁶O) is 99.7317 molecular % (mol. %) and major deuterium-containing isotopologue HOD (H¹⁶OD) is 0.0311 mol. % (Vienna Standard Mean Ocean Water, VSMOW). Rothman et al., J. Quant. Spectrosc. Radiat. Transfer, 1998, 60, 665. Rothman et al., J. Quant. Spectrosc. Radiat. Transfer, 2003, 82, p.9. Because of process of evaporation and condensation of ocean water, HOD levels in natural water slightly vary on Earth district. Only exclusion is natural water of Antarctica, which water contains HOD at levels of about 0.0178 mol. % (Standard Light Antarctic Precipitation, SLAP). A majority of people reside at Earth districts where they consume natural water with HOD levels from 0.0280 to 0.0311 mol. %. On a calculation basis, when consume 2.7 and 3.7 liters of natural water per day, women and men consume no less than 0.8 and 1.0 ml of HOD as the obligate nutrient per day, respectively.

We discovered that HOD is a highly undesirable nutrient for subjects suffering from prolonged occupational stress and HOD restriction may represent a special determined nutrient requirement for the dietary management of burnout, which cannot be achieved by the modification of the normal diet alone. Surprisingly, we found that mammals are highly sensitive to HOD levels in drinking water and even change of HOD content in drinking water within the range of HOD natural concentrations provides a significant effect on susceptibility to occupational stress and predisposition to the development of burnout. Thus, the dietary management of burnout can be achieved by restriction of HOD daily consumption.

It is an object of the present invention is to provide a food for the dietary management of burnout comprising a water containing from 0.0002 to 0.0278 molecular % of isotopologue HOD.

It is an object of the present invention is to provide a method of the dietary management of burnout comprising a step of administering to a subject in need thereof the food of the invention.

### DETAILED DESCRIPTION OF THE INVENTION

The present invention provides a food for the dietary management of burnout comprising a water containing from 0.0002 to 0.0278 molecular % of isotopologue HOD.

In a preferred embodiment of the invention, the food comprises water containing from 0.0178 to 0.0278 molecular % of isotopologue HOD.

As used herein, the term “food” refers to a food which is formulated to be consumed or administered enterally and which is intended for the specific dietary management of burnout.

In a preferred embodiment of the invention, the food is selected from a group consisting of solid food, liquid food, beverage, and drinking water.

As used herein, the term “burnout” refers to the state of vital exhaustion in meaning of International Classification of Disease, ICD-10 or subsequent editions. Frequently, burnout is the state of physical, emotional and mental exhaustion that results from chronic occupational stress. Burnout can be measured by a method well-known to a skilled person. The nonexclusive examples of well-known measurement of burnout are the Maslach Burnout Inventory, Shirom-Melamed Burnout Questionnaire, and burnout ,test of Jan Boettcher. The burnout syndrome includes nonexclusively emotional exhaustion, depersonalization, fatigue, and reduced personal accomplishment.

As used herein, the term “isotopologue” is in accordance with IUPAC Compendium of Chemical Terminology 2nd Edition (1997) and refers to a molecular entity that differs only in isotopic composition (number of isotopic substitutions). Examples of such isotopologues include H₂¹⁶O, H₂¹⁷O, H₂¹⁸O, H¹⁶OD, H17OD, ¹H¹⁸OD, D₂¹⁶O, D₂¹⁷O, and D₂¹⁸O. The isotopologue H¹⁶OD is indicated in the present invention as HOD.

In preferred embodiments of the invention, HOD content in the water can be determined by methods well-known from the art. HOD levels can be directly measured by laser spectrometry. R. Van Trigt. R. van Trigt. Laser Spectrometry for Stable Isotope Analysis of Water Biomedical and Paleoclimatological Applications. 2002, Groningen: University Library Groningen. Also, HOD levels can be determined by conventional isotope mass-spectrometry as D/H ratio and re-calculated to HOD contents given that content of other deuterium-containing isotopologues in water is negligible as compared to HOD. For the reference, VSMOW water contains 0.00006 mol. % H¹⁸OD; 0.00001 mol. % H¹⁷OD; and less than 0.00001 mol. % for sum of isotopologues D₂¹⁶O, D₂¹⁷O, and D₂¹⁸O. The range 0.0002 to 0.0278 mol. % of isotopologue HOD in the water of the invention corresponds to the range of D/H ratio 1 to 139 ppm. The range 0.0178 to 0.0278 mol. % of isotopologue HOD in the water of the invention corresponds to the range of deuterium content 89 to 139 ppm.

In preferred embodiments of the invention, the water containing 0.0002 to 0.0278 mol. % of isotopologue HOD can be prepared by a variety of industrial procedures well-known from the art, e.g. vacuum distillation of natural water. The water containing 0.0178 to 0.0278 mol. % of isotopologue HOD can be obtained from rare natural sources (e.g. Antarctic precipitations) or prepared by a variety of industrial procedures well-known from the art, e.g. vacuum distillation of natural water.

In practicing the invention, the water containing 0.0002 to 0.0278 mol. % of isotopologue HOD may contain other water isotopologues at levels equal or other than natural ones, e.g. 0<H₂¹⁸O≦0.2000 mol. %; 0<H₂¹⁷O≦50.0370 mol. %; 0<H¹⁷OD≦0.0270 mol. %; 0<H¹⁸OD≦0.0270 mol. %; 0<D₂¹⁶O≦0.0270 mol. %; 0<D₂¹⁷O≦0.0270 mol. %; and 0<D₂¹⁸O≦0.0270 mol. %, and 0<H₂¹⁶≦99.9998 mol. %.

The food of the invention may be prepared by well-known procedures using well-known optional ingredients. Such optional ingredients generally are used individually at levels from about 0.0005% to about 10.0%, preferably from about 0.005% to about 1.0% by weight of the composition. Examples of suitable optional ingredients include, but are not limited to, buffers, sweeteners, colorants, carriers, and etc.

In the preferred embodiments of the invention, the food is a liquid food specially formulated and manufactured in form of drinking water or beverage. The liquid food may be prepared by saturation of water containing 0.0002 to 0.0279 mol. % of isotopologue HOD with carbon dioxide or/and inorganic salts typically abandoned in natural drinking water. The examples of such salts include, but are not limited to, sodium chloride, sodium bicarbonate, calcium chloride, magnesium sulfate, etc.

Further, the present invention provides a method of the dietary management of burnout comprising a step of administering to a subject in need thereof the food of the present invention.

In practicing the method of the invention, the food can be administered orally for a period of one day or longer and in amounts as prescribed by a skilled person which manages the diet and/or provides medical supervision.

In practicing the method of the invention, the food may be formulated as the drinking water or beverage that can be administered in amounts from 0.1 to 4.0 liters per subject per day.

As used herein, the term “subject” refers to a human.

The following examples are presented to demonstrate the invention. The examples are illustrative only and are not intended to limit the scope of the invention in any way.

### Example 1

Table 1 demonstrates water samples comprising 0.0002 to 0.0278 molecular % of isotopologue HOD for the preparing the food of the invention. Samples of water containing isotopologue HOD within the range of its natural concentrations 0.0178 to 0.0278 mol. % were prepared by mixing the control natural water (0.0300 mol. % HOD) with water prepared vacuum distillation at 60° C. and pressure 0.2 bars (0.0178 mol. % HOD) in certain proportions. Samples of water containing isotopologue HOD within the range of 0.0002 to 0.0278 mol. % were prepared by long-term vacuum distillation of natural water at 60° C. and pressure 0.2 bars. HOD levels were measured by isotope laser spectroscopy.

TABLE 1

| | HOD content, | Corresponds to D |
|---|---|---|
| Sample | molecular % | content, ppm |
| Water No 1 (control) | 0.0300 | 150 |
| Water No 2 | 0.0278 | 139 |
| Water No 3 | 0.0178 | 89 |
| Water No 4 | 0.0002 | 1 |

### Example 2

Table 2 demonstrates the food for the dietary management of burnout in form of liquid beverage.

TABLE 2

| | |
|---|---|
| Ingredient | Content, wt % |

Beverage No. 1

| | |
|---|---|
| Water (0.0300 molecular % HOD) | 99.953 |
| Calcium Chloride | 0.015 |
| Magnesium Chloride | 0.007 |
| Sodium Bicarbonate | 0.025 |

Beverage No. 2

| | |
|---|---|
| Water (0.0178 molecular % HOD) | 99.953 |
| Calcium Chloride | 0.015 |
| Magnesium Chloride | 0.007 |
| Sodium Bicarbonate | 0.025 |

Beverage No. 3

| | |
|---|---|
| Water (0.0278 molecular % HOD) | 99.953 |
| Calcium Chloride | 0.015 |
| Magnesium Chloride | 0.007 |
| Sodium Bicarbonate | 0.025 |

Beverage No. 4

| | |
|---|---|
| Water (0.0002 molecular % HOD) | 99.953 |
| Calcium Chloride | 0.015 |
| Magnesium Chloride | 0.007 |
| Sodium Bicarbonate | 0.025 |

Calcium Chloride, Magnesium Chloride, and Sodium Bicarbonate are dissolved in the Water under room temperature and, then, resulted product is bottled in bottles of 330 ml volume.

### Example 3

This example demonstrates that HOD is the undesirable obligate nutrient in drinking water that predisposes to the development of burnout. Two groups of people by nine persons per group with high level of occupational stress due to a high frequency of contacts with clients drink Beverage No. 1 (control) or Beverage No. 2 of the example 2 of the present invention for one month without limitation. Average burnout levels in the groups before and one month after the use of abovementioned beverages were assessed with use of burnout test of Jan Boettcher (27 questions), which provides test results as burnout index in percent. Data are presented in Table 3 as mean ±SEM of average change of personal burnout indexes calculated by the equation [(Bt-B0)/B0]×100%, wherein BO is the personal burnout index before and Bt is the personal burnout index after the use of beverages.

TABLE 3

| Group | [(Bt-B0)/B0] × 100%, % |
|---|---|
| Beverage No.1 (control) | 3 ± 8 |
| Beverage No. 2 (low HOD) | −34 ± 11* |

*Differs significantly of control (P < 0.05).

These results suggest that use of water of the present invention with lower content HOD as drinking water is useful for reducing burnout index, meaning that HOD is a very undesirable nutrient under occupational stress and HOD restriction may represent a special determined nutrient requirement for the dietary management of burnout.

1. A food for the dietary management of burnout comprising a water containing from 0.0002 to 0.0278 molecular % of isotopologue HOD.

2. The food of claim 1, wherein the water contains from 0.0178 to 0.0278 molecular % of isotopologue HOD.

3. The food of claim 1, wherein the food is selected from a group consisting of solid food, liquid food, beverage, and drinking water.

4. A method of the dietary management of burnout comprising a step of administering to a subject in need thereof the food of claim 1.

5. The method of claim 4, wherein the subject is a human.
